(19) United States
(12) Patent Application Publication
(10) Pub. No.: US 2019/0315647 A1
(43) Pub. Date: Oct. 17, 2019

(54) SAG-ASSIST ARTICULATED TOOLING DESIGN FOR GLASS BENDING

(71) Applicant: CORNING INCORPORATED, CORNING, NY (US)

(72) Inventor: Chao Yu, Horseheads, NY (US)

(21) Appl. No.: 16/343,103

(22) PCT Filed: Oct. 20, 2017
(86) PCT No.: PCT/US2017/057538

§ 371 Date: Apr. 18, 2019

Related U.S. Application Data
(60) Provisional application No. 62/410,492, filed on Oct. 20, 2016.

(51) Int. Cl. C03B 23/027; C03B 23/025

(52) U.S. Cl. CPC C03B 23/027; C03B 23/0258; C03B 23/0256; C03B 23/0252

(57) ABSTRACT

A sag-assist articulated tooling apparatus is described for complex, non-developable thin glass bending. The tooling apparatus employs a double-axis articulation design which introduces controllable external force in addition to glass gravity itself. The tooling apparatus described an articulated section along the primary bending direction and an articulated section along the cross bending direction. Each articulated section may include a hinge tower, counterweight, swing stopper, and counterweight stopper.

### CROSS-REFERENCE TO RELATED APPLICATIONS

This application claims the benefit of priority under 35 U.S.C. § 119 of U.S. Provisional Application Ser. No. 62/410,492 filed on Oct. 20, 2016, the content of which is relied upon and incorporated herein by reference in its entirety.

### BACKGROUND

### Field

The present disclosure relates to tooling design for thin sheet glass bending processes. Thin sheet glass bending processes have potential application for formation of automotive glass (e.g., windshield, sidelite, backlite, and roof). Such processes may also be used in the formation of aerospace transparencies, high-speed train glass, and 3-D display glass.

### Background

Glass heating ovens, conveyor systems or lehrs, and bending apparatus are often employed for sheet glass bending in the automotive industry. Existing sheet glass bending processes include gravity bending, press bending, and roll forming. In general, gravity bending relies on the force of gravity to conform glass at high temperature on stationary or articulated tooling. In press bending, heated glass is formed by pressing glass from an upper mold to a lower mold, which are also known as male and female molds. Roll forming engages two sets of shaping rolls to form the glass to the designed shape. As both press bending and roll forming unavoidably have glass surface contact with tooling, gravity bending is usually preferred especially for those products with high optical quality requirements, such as automotive glass. Overall, existing technologies work well when dealing with developable surfaces and simple compound surfaces.

Currently auto makers are more and more concerned with aerodynamic performance and fuel efficiency. Accordingly, future auto glass development will likely demand more aerodynamic, complex, and asymmetric shapes for larger and thinner glass. Certain constraints with existing bending technologies, however, have been identified for bending a thin sheet glass with a complex, non-developable shape. A next generation technology is needed for bending such complex shapes to achieve high quality contour and optics.

### BRIEF SUMMARY

The present disclosure is directed to apparatuses for gravity bending sheet glass, and related methods.

In one embodiment, an apparatus for gravity bending sheet glass includes a base frame, a first primary articulated section coupled to the base frame, and a first cross articulated section coupled to the base frame. The first primary articulated section includes a first primary swing configured to permit gravity bending of the sheet glass along a primary bending direction of the sheet glass. The first cross articulated section includes a first cross swing configured to permit gravity bending of the sheet glass along a cross bending direction of the sheet glass. The first primary swing is configured to pivot from an open position to a closed position due to gravity bending of the sheet glass, wherein the closed position of the first primary swing is configured to permit bending of the sheet glass to a shape having more curvature in the primary bending direction than permitted by the open position of the first primary swing. The first cross swing is also configured to pivot from an open position to a closed position due to gravity bending of the sheet, wherein the closed position of the first cross swing is configured to permit bending of the sheet glass to a shape having more curvature in the cross bending direction than permitted by the open position of the first cross swing.

In one embodiment, each articulated section of the apparatus for gravity bending sheet glass includes a swing stopper that is configured to limit pivoting of the respective swing at the open position of the respective articulated section, a counterweight opposite the respective swing, and a counterweight stopper that is configured to limit pivoting of the counterweight at the closed position of the respective articulated section.

In one embodiment, each articulated section of the apparatus for gravity bending sheet glass further includes a counterweight bar supporting the respective counterweight of each articulated section and a hinge tower coupled to the base frame, wherein the counterweight bar and the swing of each respective articulated section are pivotably mounted on the respective hinge tower.

In one embodiment, the apparatus further includes a second primary articulated section coupled to the base frame. The second primary articulated section is configured to permit gravity bending of the sheet glass along a primary bending direction of the sheet glass The second primary articulated section has a second primary swing that is configured to pivot from an open position to a closed position due to gravity bending of the sheet glass to assist in bending the sheet glass in the primary bending direction.

In one embodiment, the apparatus further includes a heating element that is configured to heat the sheet glass.

In one embodiment, the heating element includes an infrared-based heating element configured to provide radiated heat.

In one embodiment, the apparatus further includes a heat shield that is configured to block direct heating to a predefined portion of the sheet glass.

In one embodiment, the heat shield has an annular shape and the predefined portion of the sheet glass is an outer annular portion of the sheet glass.

In one embodiment, the heat shield configured to block heating to about half of the sheet glass.

In one embodiment, the apparatus is configured for gravity bending of sheet glass with a thickness range from about 0.5 mm to 1.0 mm.

In one embodiment, the first primary swing is configured to assist in bending the sheet glass in the primary bending direction to form a predetermined, developable shape and the first cross swing is configured to assist in bending the sheet glass in the cross bending direction to form a predetermined, non-developable shape.

In one embodiment, a method includes placing a glass sheet on a gravity bending tool for bending glass sheets and applying heat in first and second heating stages. The gravity bending tool includes a base frame, a first primary articulated section coupled to the base frame, and a first cross articulated section coupled to the base frame. The first primary articulated section includes a first primary swing configured to permit gravity bending of the sheet glass along a primary bending direction of the sheet glass. The first cross articulated section includes a first cross swing configured to permit gravity bending of the sheet glass along a cross bending direction of the sheet glass. The first primary swing is configured to pivot from an open position to a closed position due to gravity bending of the sheet glass, wherein the closed position of the first primary swing is configured to permit bending of the sheet glass to a shape having more curvature in the primary bending direction than permitted by the open position of the first primary swing. The first cross swing is also configured to pivot from an open position to a closed position due to gravity bending of the sheet, wherein the closed position of the first cross swing is configured to permit bending of the sheet glass to a shape having more curvature in the cross bending direction than permitted by the open position of the first cross swing.

The first heating stage includes applying heat from a heating element to the sheet glass, while the first primary articulated section and the first cross articulated section are in the open position, to cause gravity bending of the heated sheet glass in the primary direction and pivoting of the first primary articulated section to the closed position in response to a change in the weight distribution of the glass sheet on the primary swing.

The second heating stage includes applying heat from the heating element to the sheet glass while the first primary articulated section is in the closed position and the first cross articulated section is in the open position, to cause gravity bending of the heated sheet glass in the cross direction and pivoting of the first cross articulated section to the closed position in response to a change in the weight distribution of the glass sheet on the cross swing.

In one embodiment, the first heating stage forms a predetermined, developable shape and the second heating stage forms the predetermined, non-developable shape.

In one embodiment, a method further includes placing a heat shield between the heating element and the gravity bending tool before the second heating stage.

In one embodiment, the heat shield reduces heating to a predefined portion of the sheet glass. In one embodiment, the predefined portion of the sheet glass is an outer annular portion of the sheet glass.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a schematic of gravity glass bending with a ring iron tooling apparatus, according to an embodiment.

FIG. 2 illustrates a sheet glass exhibiting bathtub behavior.

FIG. 3 shows a top view of shape contour deviation of a deformed shape compared to nominal under uniform heating.

FIG. 4 shows a comparison of glass deformation along a center cross curve.

FIG. 5 illustrates three different overlapping shield design examples.

FIG. 6 illustrates a non-uniform thermal regime applied to the sheet glass created by edging shielding.

FIG. 7 illustrates a comparison of glass deformed shape with different shielding designs to nominal in a manner similar to FIG. 4.

FIG. 8 illustrates edge buckling of a sheet glass.

FIG. 9 shows a deformation contour plot for a windshield.

FIG. 10 shows a stress intensity plot for a windshield.

FIG. 11A illustrates the tooling apparatus in an initial, open position, according to an embodiment.

FIG. 11B illustrates the tooling apparatus in a final, closed position, according to the embodiment of FIG. 11A.

FIG. 11C illustrates the tooling apparatus from a top perspective, according to the embodiment of FIG. 11A.

FIG. 11D illustrates the tooling apparatus from a side perspective, according to the embodiment of FIG. 11A.

FIG. 12 illustrates a gravity glass bending process, according to an embodiment.

FIG. 13 illustrates temperature profile during a gravity glass bending process, according to an embodiment.

FIG. 14 illustrates another non-uniform thermal regime applied to the sheet glass created by edging shielding and corresponding to FIG. 13.

### DETAILED DESCRIPTION

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. When a numerical value or end-point of a range does not recite “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

As used herein, “comprising” is an open-ended transitional phrase. A list of elements following the transitional phrase “comprising” is a non-exclusive list, such that elements in addition to those specifically recited in the list may also be present.

The term “or,” as used herein, is inclusive; more specifically, the phrase “A or B” means “A, B, or both A and B.” Exclusive “or” is designated herein by terms such as “either A or B” and “one of A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

The term “wherein” is used as an open-ended transitional phrase, to introduce a recitation of a series of characteristics of the structure.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

A sag-assist articulated tooling apparatus is described for complex, non-developable thin glass bending. The tooling apparatus employs double-axis articulation design which introduces controllable external force in addition to glass gravity itself. Unlike typical articulated tooling design, the tooling apparatus described herein includes an articulated section along the primary bending direction and an articulated section along the cross bending direction. Each articulated section may include of a hinge structure, counterweight, swing stopper, and counterweight stopper.

In a typical articulated tooling design, only single-axis articulation is used to assist glass bending along the primary bending direction only. The tooling apparatus described herein, by contrast, expands primary-bending design to a cross-bending direction. With one or more articulation sections along the cross bending direction, the tooling apparatus described herein provides enhanced support to form glass with deeper cross bend curvature.

The glass bending process and apparatus is described below. At sheet glass loading position, all swings are in open position and are supported by swing stoppers located underneath the rails of the swings. During the initial bending stage, the sheet glass bends elastically and deforms following primary swing articulation, i.e., bending in a primary direction. When the primary swings close completely, the sheet glass is formed into a developable shape, such as a cylindrical- or conical-like shape. At this point, the sheet glass has a gentle touch to the rails of cross swings. With continuing glass relaxation, the process proceeds to the viscoelastic bending stage. The center portion of sheet glass starts to sag, which triggers the cross swings to close. The cross swings stop moving when their counterweight bars touch the counterweight stoppers and the sheet glass shape is formed into a non-developable shape.

In this sequential dynamic process, sheet glass is fully supported by the tooling apparatus through the whole bending cycle. This ensures process repeatability. Moreover, the addition of cross articulation is beneficial for the glass to achieve deeper chord height or sag. Due to the edge constraint, buckling and bathtub behavior may be eliminated. Other benefits of the process include achieving lower glass bending temperature, reducing cause of process defects, and improving glass optical quality with minimum tool marks.

Tooling calibration is required at initial testing to ensure proper bending dynamic in the process. The general procedures include: counterweight and location setup, swing stopper height adjustment, and counterweight stopper height adjustment. These ensure proper behavior of the tooling apparatus during the bending process.

In comparison to prior designs, the tooling apparatus has the following advantages: (a) elimination of edge buckling for parts with deep cross curvature or chord height; (b) improved shape accuracy with enhanced edge support; (c) lower glass bending temperature and reduce cause of process defects; (d) controlled surface contour through guided bending with full dynamic support; and (e) improved glass optical quality with minimum tool marks. Further details and advantages are provided herein.

### Overview of Gravity Bending with Ring Iron Support

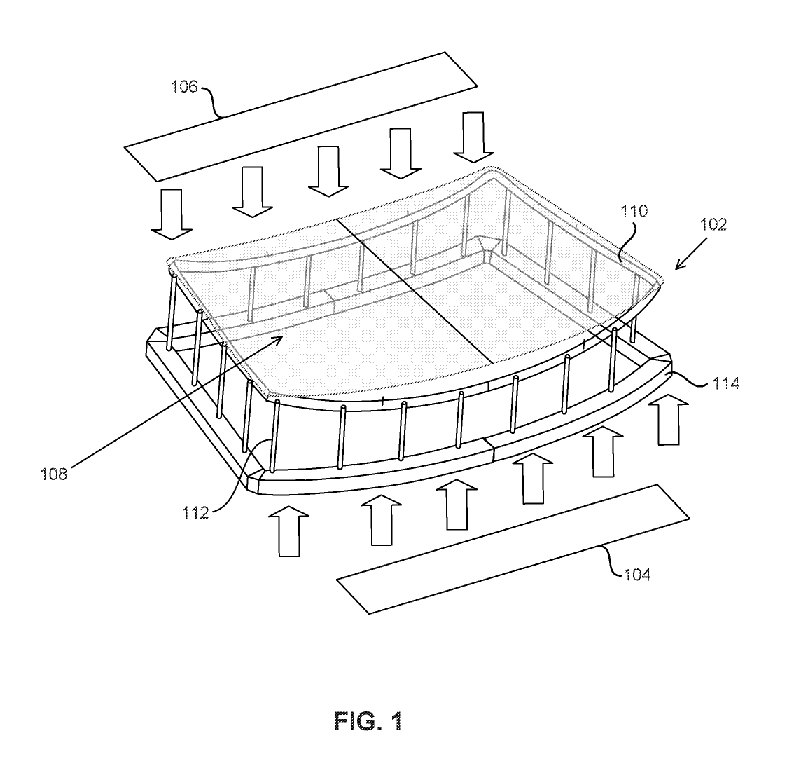

In a typical gravity glass bending process, a heating element, tooling support and conveyor system are the three key components. FIG. 1 illustrates a schematic of gravity glass bending with a ring iron tooling apparatus 102. A first heating element 104 and a second heating element 106 may provide radiated heat to a preform sheet glass 108. Heating elements 104, 106 may be infrared-based electrical heaters to provide radiated heat. Through individual loop control, the power output from each heating elements 104, 106 may be respectively controlled to achieve a predetermined temperature profile based on the glass shape to bend. Ring iron 102 may include a rail 110, supporting bars 112, and a base structure 114. The rail width may be between about 2-4 mm, and the height may be between 20-30 mm. The ring iron 102 may be made of stainless steel. A stainless steel cloth may be used on top of the rail to reduce tool marks that may result from glass-tooling contact. Boron nitride may also be used to enhance contact surface smoothness. A metal carbide coating may also be used to improve rail surface durability. To maintain process repeatability, loading stoppers (not shown) may also be used and mounted on two sides of the rail to provide loading guidance.

Gravity or sag bending has proved challenging in the formation of non-developable surfaces. As known in the art, a developable surface is a special ruled surface with zero Gaussian curvature. A developable surface can be formed by bending or rolling a planar surface without stretching or tearing. Thus, a developable surface can be unrolled isometrically onto a plane. Cylindrical surfaces and conical surfaces are examples of developable surfaces. By contrast, a non-developable surface has non-zero Gaussian curvature and, thus, is not developable surface. A spherical surface, for example, is a non-developable surface because it cannot be unrolled onto a plane.

### Challenges of Thin Glass Bending

Bending thin sheet glass with gravity bending into a non-developable surface presents unique challenges. The thin glass discussed herein generally has a thickness range from about 0.5 mm to 1.0 mm. Two main challenges have been identified in glass bending processes in this glass thickness range: bathtub behavior and edge buckling.

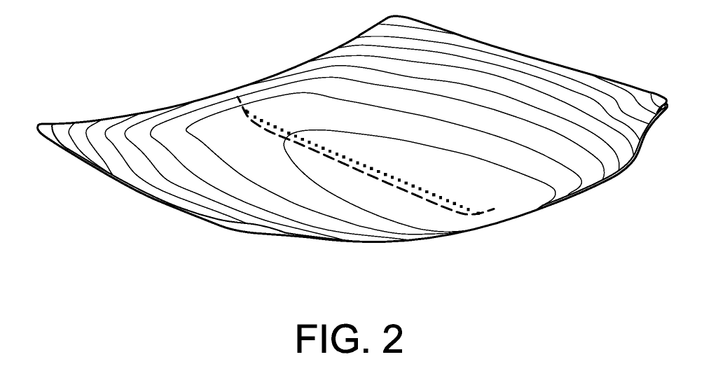

Bathtub behavior is illustrated in FIG. 2. Bathtub behavior is a phenomenon of glass forming into a bathtub-like shape which shows over-bending at the edge but under-bending close to glass center. The shading in FIG. 2 represents different bending depths, and the dotted line illustrates bending along a center cross curve. Glass bending trials have discovered this behavior when uniform heating is applied. This discovery has also been confirmed through numerical simulations with a glass bending viscoelastic model.

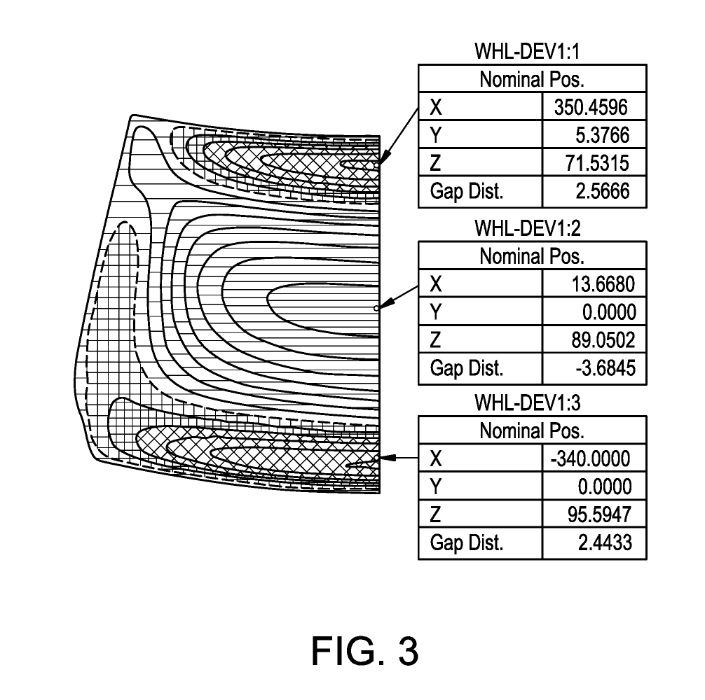

In a recent shape error prediction project, a windshield was studied with a modeling approach. Shape contour deviation of a deformed shape from the nominal was studied. FIG. 3 depicts the results of the project. FIG. 3 shows a top view of shape contour deviation of a deformed shape compared to nominal under uniform heating. The top and bottom regions of the graph (outlined by dotted lines) show sheet glass over-bending, while the middle region represents under-bending. The deformed shape is obtained through a viscoelastic-based glass bending model at a uniform heating condition.

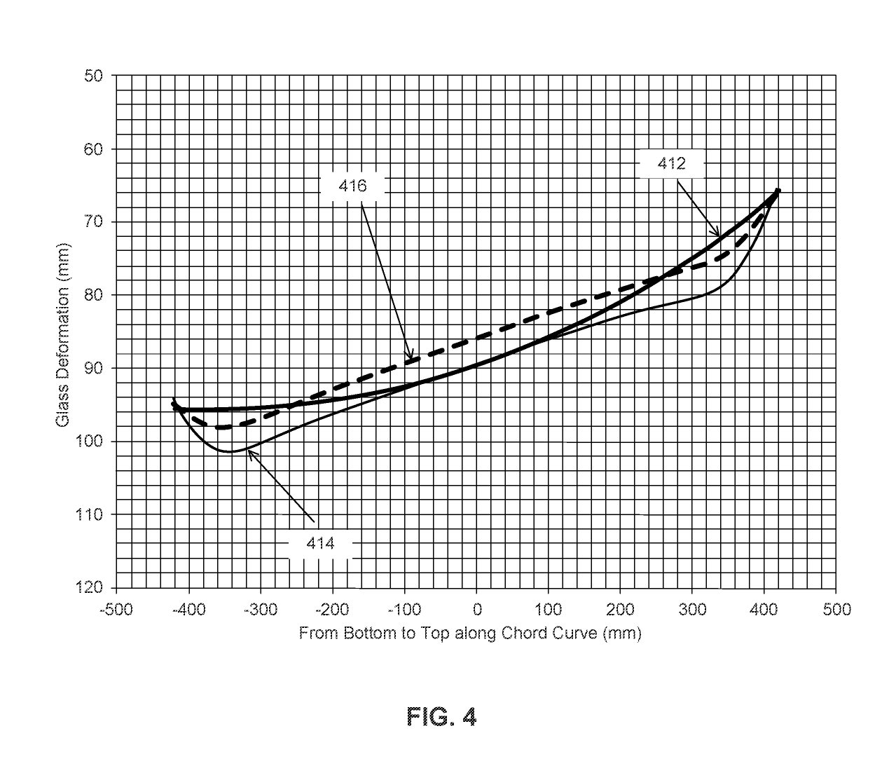

FIG. 4 further illustrates the bathtub behavior by showing a comparison of glass deformation along a center cross curve. Thick solid line 412 is the nominal curve. Thin solid line 414 represents glass deformed shape when reaching the maximum depth of bend. Dashed line 416 is glass deformed shape with minimum overall shape error. Both thin solid line 414 and dashed line 416 are numerical modeling results for glass bending at a uniform heating condition.

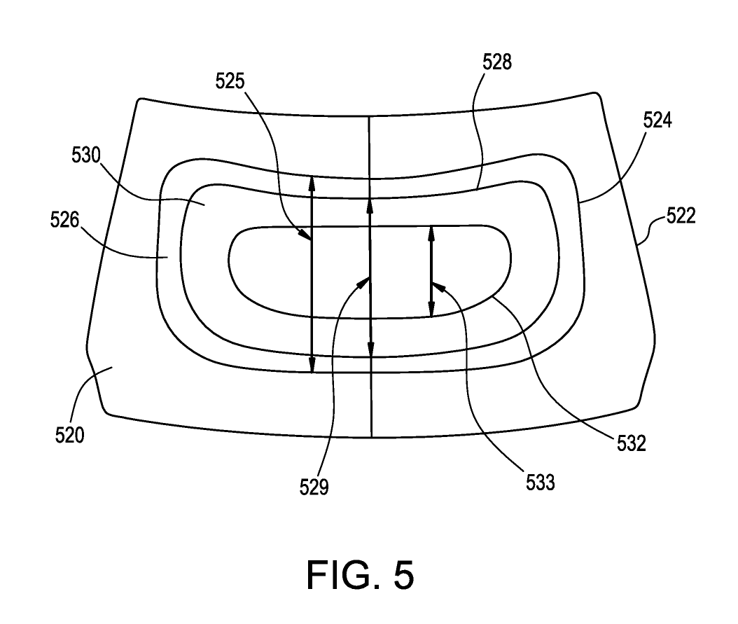

To correct the bathtub behavior, a passive control approach may be employed that allows for non-uniform heating of the sheet glass. A top or bottom annular shield may be placed between a heating element and the sheet glass to reduce sheet glass edge temperature. FIG. 5 illustrates three different overlapping shield design examples. A first shield 520 has an outer edge 522 commensurate with the outer edge of a preform sheet glass. For example, in the embodiment shown, outer edge 522 has the outer shape of an automotive windshield. First shield 520 has an inner edge 524 defining an opening 525 in first shield 520. The size and shape of opening 525 is designed such that first shield 520 has a 60% shielding area that blocks heat from the heating element. A second shield 526 has the same outer edge 522 commensurate with the outer edge of a preform sheet glass, but second shield 526 has an inner edge 528 defining an opening 529. The size and shape of opening 529 is designed such that second shield 526 has a 50% shielding area that blocks heat from the heating element. A third shield 530 has the same outer edge 522 commensurate with the outer edge of a preform sheet glass, but third shield 530 has an inner edge 532 defining an opening 533. The size and shape of opening 533 is designed such that third shield 530 has a 30% shielding area that blocks heat from the heating element.

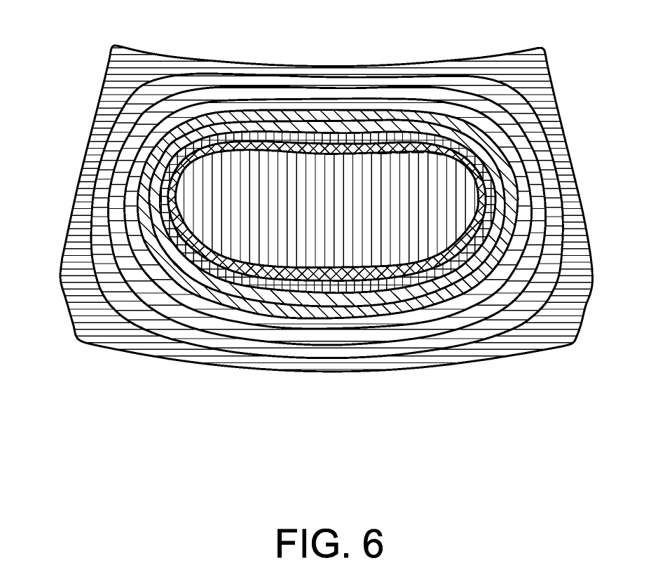

FIG. 6 illustrates a non-uniform thermal regime applied to the sheet glass created by edging shielding. The contour lines connect points of equal temperature. In FIG. 6, the outermost edge is the coolest area, with each concentric area increasing in temperature. Thus, the center area represents the hottest area and is unshielded.

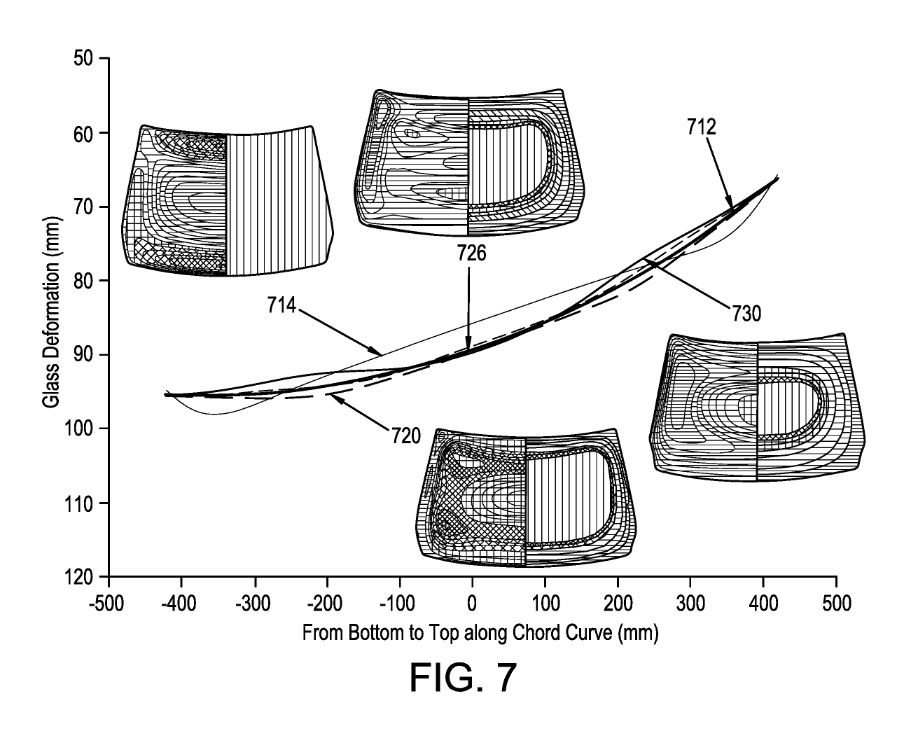

Returning to the three shield design examples from FIG. 5, each design with a different shielding area has been simulated and evaluated. FIG. 7 illustrates a comparison of glass deformed shape with different shielding designs to nominal in a manner similar to FIG. 4. A thick solid line 712 represents a nominal design and the desired shape along a center cross curve of the sheet glass. A uniform heating design 714 is illustrated by thin solid line along a center cross curve for comparison. A corresponding split map is also shown. The left side of the map depicts a shape contour deviation of a deformed shape from the nominal identical to FIG. 3. The right side illustrates a uniform thermal regime similar to FIG. 6. A first shielding design 720 corresponds to a shielding design with first shield 520. A second shielding design 726 corresponds to a shielding design with second shield 526. A third shielding design 730 corresponds to a shielding design with third shield 730. Each also has corresponding split maps. Again, a shape contour deviation of a deformed shape from the nominal is shown on the left and a thermal regime is shown on the right of each map.

When compared with uniform heating design 714, shape improvement has been observed with all shield design options. There is a slight “over” bending with first shielding design 720, while there is some “under” bending with third shielding design 730. Overall, second shielding design 726 with 50% of shielding area shows the best contour agreement. As a result, it is clear to see that introduction of a shielding design compensates for bathtub behavior to a certain extent.

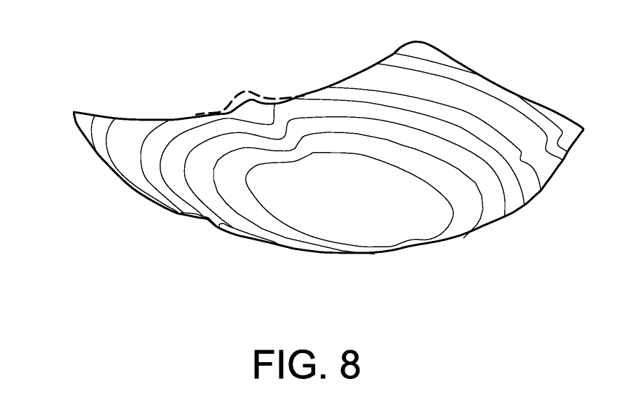

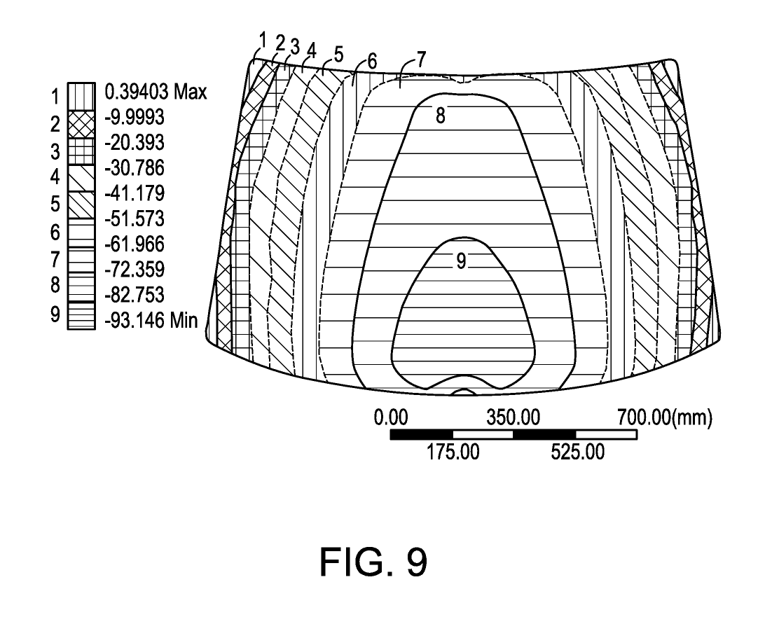

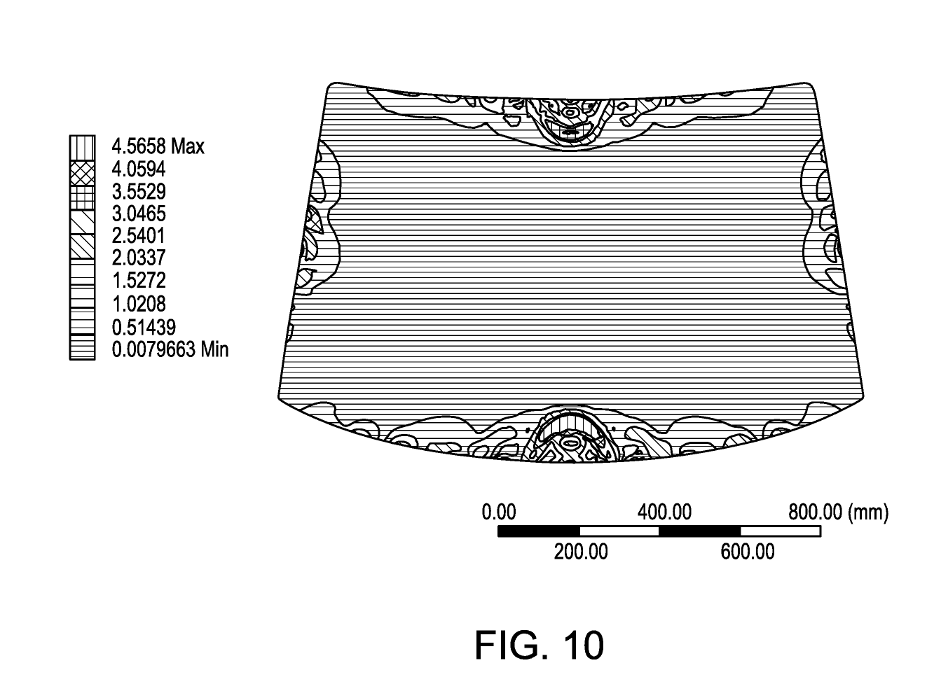

The second challenge of thin glass bending into a non-developable shape is edge buckling. Edge buckling is caused by membrane stress, specifically surface compression, during glass bending. Edge buckling has always occurred at the viscoelastic stage when glass is developing larger cross curvature. Portions of the sheet glass with higher chord height/cross curvature have a higher possibility of buckling both experimentally and numerically. In addition, edge buckling is also believed to be related to glass edge constraint. Sheet glass portions with a different corner shape have a different buckling response. FIG. 8 illustrates edge buckling, which is emphasized by a dotted line. FIGS. 9 and 10 show math modeling results for a windshield. The buckling can be observed clearly in the deformation contour plot of FIG. 9. And the stress intensity plot in FIG. 10 shows the stress concentration at locations where buckling occurs.

A special articulated tooling and bending process has been developed to address both bathtub behavior and edge buckling.

### Sag-Assist Articulated Tooling Apparatus

In typical articulated tooling design, a single axis of articulation is used to assist glass bending along the primary bending direction only. The single-axis articulation could include double symmetrical wings to provide moving support to achieve glass bending in the primary direction, e.g., US Patent Application Publication No. 2005/0092028 A1. One tooling design has included only one wing for asymmetric shape bending, e.g., US Patent Application Publication No. 2015/0152002 A1. US Patent Application Publication No. 2010/0064730 A1 proposed another tooling design with a double-rail articulation design. All these designs are within a single-axis articulation regime focusing on primary bending of the shapes. They are efficient when dealing with developable shapes and non-developable shapes with small cross curvature. These designs, however, have limited capability to bend sheet glass with non-developable shapes with deeper cross curvature, especially for thin glass with thickness range from about 0.5 mm to 1.0 mm. One example of such thin glass is CORNING® GORILLA® Glass.

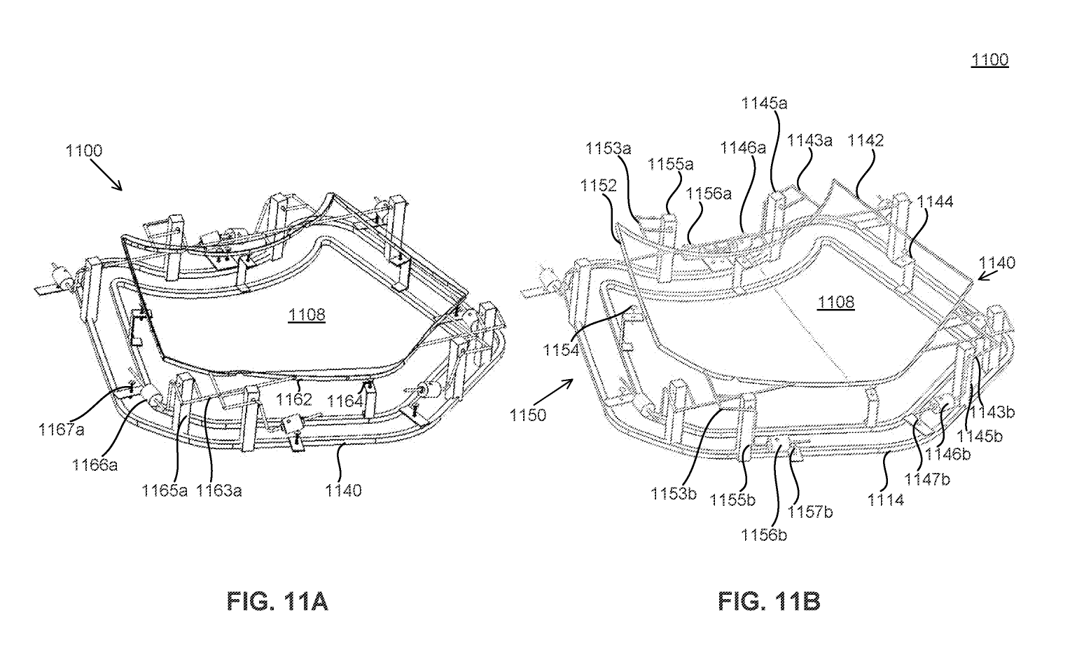

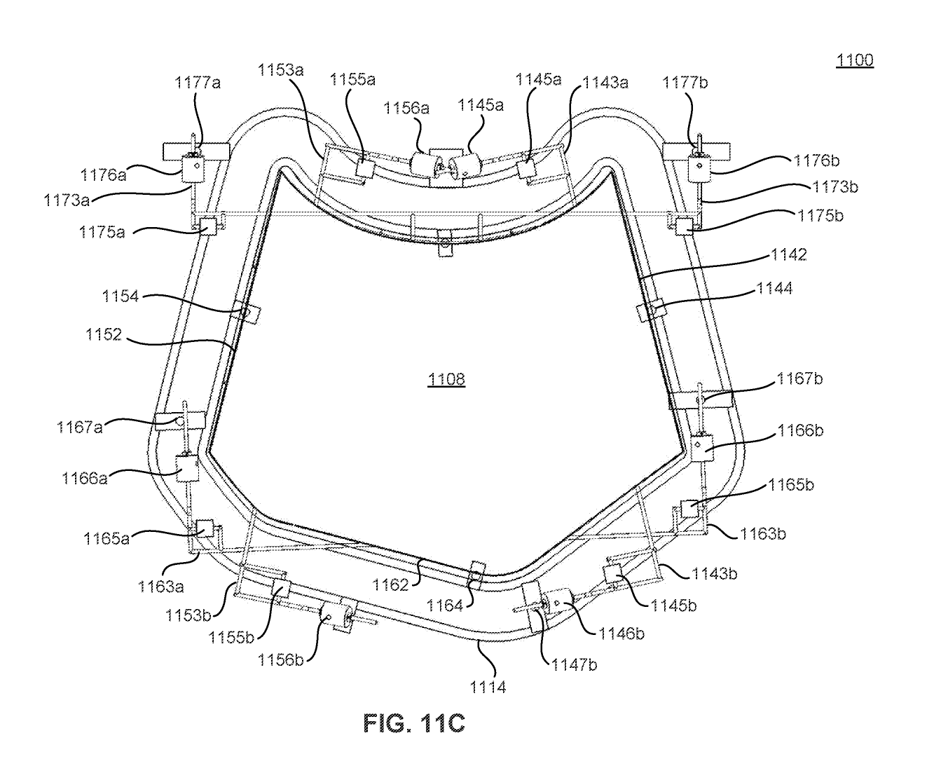

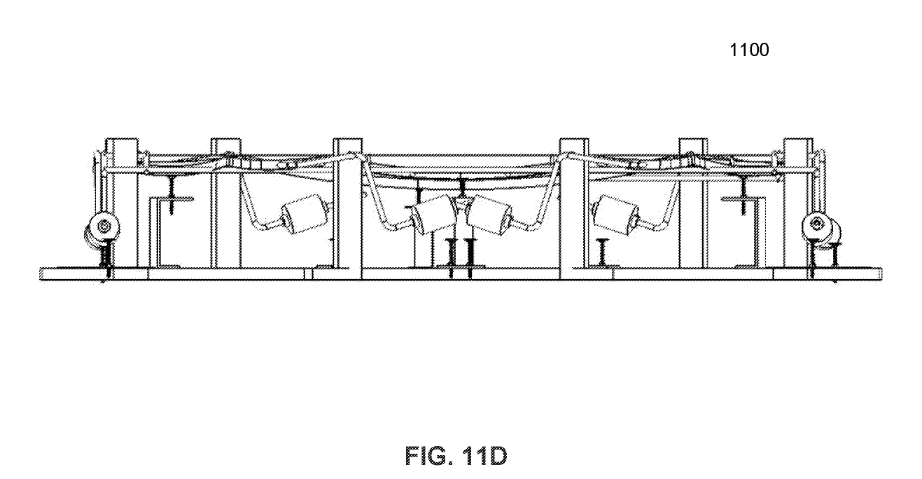

To address the challenges discussed previously for thin sheet glass bending, specifically non-developable contour, bathtub behavior, and edge buckling, a sag-assist articulated apparatus and bending process is described. FIGS. 11A-11C illustrate one embodiment of a sag-assist articulated tooling apparatus. FIG. 11A illustrates the tooling apparatus in an initial, open position. FIG. 11B illustrates the tooling apparatus in a final, closed position. FIG. 11C illustrates the tooling apparatus from a top perspective. FIG. 11D illustrates the tooling apparatus from a side perspective. Tooling apparatus 1100 employs double-axis articulation design for gravity bending sheet glass 1108, which introduces controllable external forces in both primary and cross bending directions. In one embodiment, tooling apparatus 1100 is configured for gravity bending of sheet glass with a thickness range from about 0.5 mm to 1.0 mm, although it may be used with other thickness ranges as well. Tooling apparatus 1100 includes a base frame 1114, a first primary articulated section 1140 coupled to the base frame, a second primary articulated section 1150, a first cross articulated section 1160 coupled to the base frame, and a second cross articulated section 1170 coupled to the base frame.

First primary articulated section 1140 includes a first primary swing 1141 configured to permit gravity bending of a sheet glass 1108 along a primary bending direction 1111. First primary swing 1141 includes a first primary rail 1142 for supporting sheet glass 1108 and first and second primary swing bars 1143a, 1143b to permit arcuate rotation of first primary rail 1142. First and second primary swing bars 1143a, 1143b rotate about first and second primary hinge towers 1145a, 1145b. First primary articulated section 1140 also includes a first primary swing stopper 1144 that is configured to limit pivoting of first primary swing 1141 at the open position of first primary articulated section 1140 as illustrated in FIG. 11A. First and second primary counterweights 1146a, 1146b lie on first and second primary swing bars 1143a, 1143b, respectively. In an open position, first and second primary counterweights 1146a, 1146b balance the weight of the sheet glass 1108 and first primary swing 1141. A first and second primary counterweight stoppers 1147a, 1147b are configured to respectively limit pivoting of first and second primary counterweights 1146a, 1146b at the closed position and, hence, limit rotation of first primary articulated section 1140 as illustrated in FIG. 11B.

In one embodiment, first primary swing 1141 is configured to pivot from an open position to a closed position due to gravity bending of sheet glass 1108, wherein the closed position of the first primary swing 1141 is configured to permit bending of sheet glass 1108 to a shape having more curvature in the primary bending direction than permitted by the open position of first primary swing 1141.

Second primary articulated section 1150 includes a second primary swing 1151 configured to permit gravity bending of sheet glass 1108 along a primary bending direction 1111. Second primary swing 1151 includes a second primary rail 1152 for supporting sheet glass 1108 and third and fourth primary swing bars 1153a, 1153b to permit arcuate rotation of second primary rail 1152. Third and fourth primary swing bars 1153a, 1153b rotate about a third and fourth primary hinge towers 1155a, 1155b. Second primary articulated section 1150 also includes a second primary swing stopper 1154 that is configured to limit pivoting of second primary swing 1151 at an open position of second primary articulated section 1150 as illustrated in FIG. 11A. Third and fourth primary counterweights 1156a, 1156b lie on third and fourth primary swing bars 1153a, 1153b, respectively. In an open position, third and fourth primary counterweights 1156a, 1156b balance the weight of the sheet glass 1108 and second primary swing 1151. Third and fourth counterweight stoppers 1157a, 1157b are configured to respectively limit pivoting of third and fourth primary counterweights 1156a, 1156b at the closed position and, hence, limit rotation of second primary articulated section 1150 as illustrated in FIG. 11B.

First cross articulated section 1160 includes a first cross swing 1161 configured to permit gravity bending of sheet glass 1108 along a cross bending direction 1113. First cross swing 1161 includes a first cross rail 1162 for supporting sheet glass 1108 and first and second cross swing bars 1163a, 1163b to permit arcuate rotation of first cross rail 1162. First and second cross swing bars 1163a, 1163b rotate about first and second cross hinge towers 1165a, 1165b. First cross articulated section 1160 also includes a first cross swing stopper 1164 that is configured to limit pivoting of first cross swing 1161 at the open position of first cross articulated section 1160 as illustrated in FIG. 11A. First and second cross counterweights 1166a, 1166b lie on first and second cross swing bars 1163a, 1163b, respectively. In an open position, first and second cross counterweights 1166a, 1166b balance the weight of the sheet glass 1108 and first cross swing 1161. A first and second cross counterweight stoppers 1167a, 1167b are configured to respectively limit pivoting of first and second cross counterweights 1166a, 1166b at the closed position and, hence, limit rotation of first cross articulated section 1160.

In one embodiment, first cross swing 1160 is also configured to pivot from an open position to a closed position due to gravity bending of sheet glass 1108, wherein the closed position of first cross swing 1160 is configured to permit bending of sheet glass 1108 to a shape having more curvature in the cross bending direction than permitted by the open position of first cross swing 1160.

Second cross articulated section 1170 includes a second cross swing 1171 configured to permit gravity bending of sheet glass 1108 along a cross bending direction 1113. Second cross swing 1171 includes a second cross rail 1172 for supporting sheet glass 1108 and third and fourth cross swing bars 1173a, 1173b to permit arcuate rotation of second cross rail 1172. Third and fourth cross swing bars 1173a, 1173b rotate about a third and fourth cross hinge towers 1175a, 1175b. Second cross articulated section 1170 also includes a second cross swing stopper 1174 that is configured to limit pivoting of second cross swing 1171 at an open position of second cross articulated section 1170 as illustrated in FIG. 11A. Third and fourth cross counterweights 1176a, 1176b lie on third and fourth cross swing bars 1173a, 1173b, respectively. In an open position, third and fourth cross counterweights 1176a, 1176b balance the weight of the sheet glass 1108 and second cross swing 1151. Third and fourth counterweight stoppers 1177a, 1177b are configured to respectively limit pivoting of third and fourth cross counterweights 1176a, 1176b at the closed position and, hence, limit rotation of second cross articulated section 1170.

Thus, in the embodiment shown in FIGS. 11A-11C, each articulated section of the apparatus for gravity bending sheet glass further includes a counterweight bar supporting the respective counterweight of each articulated section and a hinge tower coupled to the base frame, wherein the counterweight bar and the swing of each respective articulated section are pivotably mounted on the respective hinge tower.

With proper counterweight setup and temperature control, the articulated swings can be triggered at different glass bending stages and controllable glass bending dynamics can be achieved to realize deeper cross curvature with optimized glass bending behavior. In addition, tooling apparatus 1100 is also capable of being converted into a single-axis articulation or a single-arm articulation tooling apparatus by limiting the motion of the rest of the swing sections. This allows maximize use of the tooling for different bending needs.

In one embodiment, the first and second primary swings 1141, 1151 are each configured to assist in bending the sheet glass in the primary bending direction 1111 to form a predetermined, developable shape and first and second cross swings 1161, 1171 are each configured to assist in bending the sheet glass in the cross bending direction to form a predetermined, non-developable shape.

In one embodiment, tooling apparatus 1100 may be used with a heating element, like radiant heating elements 104 and 106 described above with respect to FIG. 1. Such heating elements may uniformly supply radiant heat toward sheet glass 1108. In one embodiment, the heating element includes an infrared-based heating element configured to provide radiated heat. In one embodiment, the apparatus further includes a heat shield, like the annular heat shield designs described with respect to FIG. 5. The heat shield may be configured to block direct heating to a predefined portion of the sheet glass. In one embodiment, the heat shield has an annular shape and the predefined portion of the sheet glass is an outer annular portion of the sheet glass. In one embodiment, the heat shield configured to block heating to about half of the sheet glass.

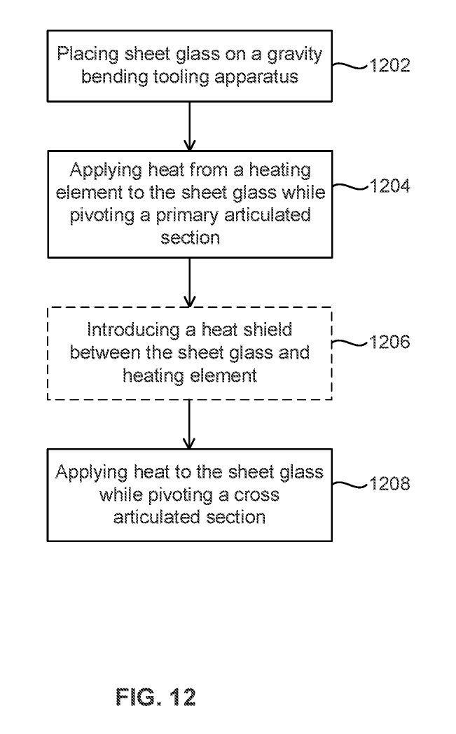

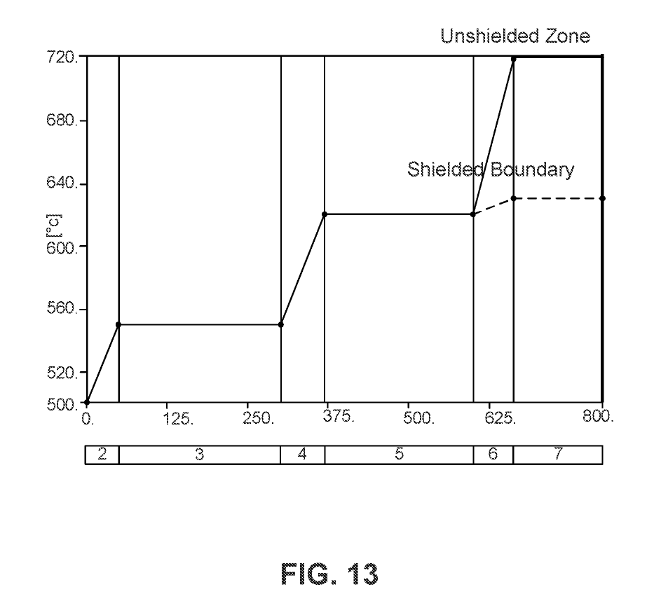

A glass bending process is described below. FIG. 12 illustrates an example method 1200. A corresponding temperature profile is schematically illustrated in FIG. 13. Glass bending process 1200 may, for example, be used in conjunction with tooling apparatus 1100. In this sequential dynamic process, the sheet glass is fully supported by the tooling apparatus through the whole bending cycle. The arrangement also ensures process repeatability. Moreover, the addition of cross articulation is beneficial for the glass to achieve deeper cross curvature, or chord height. Due to the edge constraint, it is also beneficial to eliminate edge buckling for thin glass bending. The process also achieves lower glass bending temperature and reduced cause of process defects, and improving glass optical quality with minimum tool mark.

Method 1200 starts with the tooling apparatus in a loading position. At loading position, all the swing portions open up and are supported by stoppers located underneath each rail. Prior to loading, tooling calibration is required at initial testing to ensure a proper bending during the process. In general, tooling calibration includes counterweight location setup, swing stopper height adjustment, and counterweight stopper height adjustment. This ensures proper balance and support of a preform sheet glass.

Block 1202 includes placing a glass sheet on a gravity bending tool for bending sheet glass.

Block 1204 includes a first heating and bending stage. During the first heating stage, glass deforms following primary articulation. When the primary swings (left and right) close completely, the glass is formed into a developable shape, e.g. cylindrical or conical surface, and the sheet glass has a gentle touch to the rails of cross swings. In one embodiment, heat is applied from a heating element to the sheet glass, while the first primary articulated section and the first cross articulated section are in the open position, to cause gravity bending of the heated sheet glass in the primary direction and pivoting of the first primary articulated section to the closed position in response to a change in the weight distribution of the glass sheet on the primary swing.

Block 1208 includes a second heating and bending stage. With continuing glass relaxation under high temperature, the process proceeds to the second heating stage. The center portion of sheet glass starts to sag which triggers the cross swings to close due to the mass distribution change. The cross swings follow the glass contour change and provides continuous support until reaching the final designed shape. The cross swings stop moving when their counterweight bars touch their respective stoppers and glass shape is formed.

In an embodiment, the second heating stage includes applying heat from the heating element to the sheet glass while the first primary articulated section is in the closed position and the first cross articulated section is in the open position, to cause gravity bending of the heated sheet glass in the cross direction and pivoting of the first cross articulated section to the closed position in response to a change in the weight distribution of the glass sheet on the cross swing.

In one embodiment, the first heating stage forms a predetermined, developable shape and the second heating stage forms the predetermined, non-developable shape.

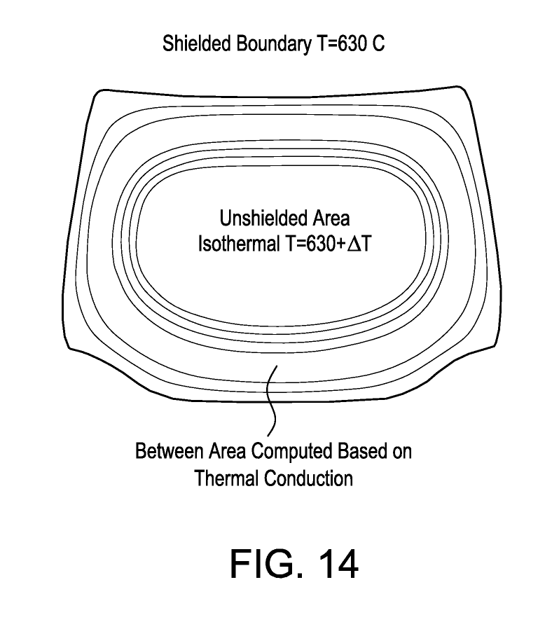

In one embodiment, a second heating and bending stage is a differential heating and bending stage that includes, at block 1206, placing a heat shield between the heating element and the gravity bending tool before a second heating stage. FIG. 13 illustrates a series of heating stages through a temperature profile. A heat shield is introduced between stages 5 and 6 in FIG. 13. The predefined shield boundary portion of the sheet glass thereafter exhibits small temperature increase while the unshielded zone continues to increase dramatically in temperature. In one embodiment, the predefined portion of the sheet glass is an outer annular portion of the sheet glass as illustrated in FIG. 14.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments, but should be defined only in accordance with the following claims and their equivalents.

What is claimed is:

1. An apparatus for gravity bending sheet glass comprising:
a base frame;
a first primary articulated section coupled to the base frame, the first primary articulated section comprising a first primary swing configured to permit gravity bending of the sheet glass along a primary bending direction of the sheet glass; and
a first cross articulated section coupled to the base frame, the first cross articulated section comprising a first cross swing configured to permit gravity bending of the sheet glass along a cross bending direction of the sheet glass;
wherein the first primary swing is configured to pivot from an open position to a closed position due to gravity bending of the sheet glass, wherein the closed position of the first primary swing is configured to permit bending of the sheet glass to a shape having more curvature in the primary bending direction than permitted by the open position of the first primary swing; and
wherein the first cross swing is configured to pivot from an open position to a closed position due to gravity bending of the sheet, wherein the closed position of the first cross swing is configured to permit bending of the sheet glass to a shape having more curvature in the cross bending direction than permitted by the open position of the first cross swing.

2. The apparatus of claim 1, wherein each articulated section further comprises:
a swing stopper, the swing stopper configured to limit pivoting of the respective swing at the open position of the respective articulated section;
a counterweight, the counterweight opposite the respective swing; and
a counterweight stopper configured to limit pivoting of the counterweight at the closed position of the respective articulated section.

3. The apparatus of claim 2, wherein each articulated section further comprises:
a counterweight bar, the counterweight bar supporting the respective counterweight of each articulated section; and
a hinge tower, the hinge tower coupled to the base frame;
wherein the counterweight bar and the swing of each respective articulated section are pivotably mounted on the respective hinge tower.

4. The apparatus of claim 1, wherein the apparatus further comprises:
a second primary articulated section coupled to the base frame, the second primary articulated section configured to permit gravity bending of the sheet glass along a primary bending direction of the sheet glass and comprising a second primary swing, wherein the second primary swing is configured to pivot from an open position to a closed position due to gravity bending of the sheet glass to assist in bending the sheet glass in the primary bending direction.

5. The apparatus of claim 4, wherein each articulated section further comprises:
a swing stopper, the swing stopper configured to limit pivoting of the respective swing at the open position of the respective articulated section;
a counterweight, the counterweight opposite the respective swing; and
a counterweight stopper configured to limit pivoting of the counterweight at the closed position of the respective articulated section.

6. The apparatus of claim 4, wherein the apparatus further comprises:
a second cross articulated section coupled to the base frame, the second cross articulated section configured to permit gravity bending of the sheet glass along the cross bending direction of the sheet glass and comprising a second cross swing; and
wherein the second cross swing is configured to pivot from an open position to a closed position due to gravity bending of the sheet glass to assist in bending the sheet glass in the cross bending direction to form the predetermined, non-developable shape.

7. The apparatus of claim 6, wherein each articulated section further comprises:
a swing stopper, the swing stopper configured to limit pivoting of the respective swing at the open position of the respective articulated section;
a counterweight, the counterweight opposite the respective swing; and
a counterweight stopper configured to limit pivoting of the counterweight at the closed position of the respective articulated section.

8. The apparatus of claim 1, further comprising a heating element, wherein the heating element is configured to heat the sheet glass.

9. The apparatus of claim 8, wherein the heating element comprises an infrared-based heating element configured to provide radiated heat.

10. The apparatus of claim 8, further comprising a heat shield, the heat shield is configured to block direct heating to a predefined portion of the sheet glass.

11. The apparatus of claim 10, wherein the heat shield has an annular shape and the predefined portion of the sheet glass is an outer annular portion of the sheet glass.

12. The apparatus of claim 10, wherein the heat shield configured to block heating to about half of the sheet glass.

13. The apparatus of claim 1, wherein the apparatus is configured for gravity bending of sheet glass with a thickness range from about 0.5 mm to 1.0 mm.

14. The apparatus of claim 1, wherein the first primary swing is configured to assist in bending the sheet glass in the primary bending direction to form a predetermined, developable shape and the first cross swing is configured to assist in bending the sheet glass in the cross bending direction to form a predetermined, non-developable shape.

15. A method comprising:
placing a glass sheet on a gravity bending tool for bending glass sheets, the gravity bending tool comprising:
a first primary articulated section coupled to the base frame, the first primary articulated section comprising a first primary swing configured to permit gravity bending of the sheet glass along a primary bending direction of the sheet glass; and
a first cross articulated section coupled to the base frame, the first cross articulated section comprising a first cross swing configured to permit gravity bending of the sheet glass along a cross bending direction of the sheet glass;
wherein the first primary swing is configured to pivot from an open position to a closed position due to gravity bending of the sheet glass, wherein the closed position of the first primary swing is configured to permit bending of the sheet glass to a shape having more curvature in the primary bending direction than permitted by the open position of the first primary swing; and
wherein the first cross swing is configured to pivot from an open position to a closed position due to gravity bending of the sheet, wherein the closed position of the first cross swing is configured to permit bending of the sheet glass to a shape having more curvature in the cross bending direction than permitted by the open position of the first cross swing;
applying heat in a first heating stage from a heating element to the sheet glass, while the first primary articulated section and the first cross articulated section are in the open position, to cause gravity bending of the heated sheet glass in the primary direction and pivoting of the first primary articulated section to the closed position in response to a change in the weight distribution of the glass sheet on the primary swing;
applying heat in a second heating stage from the heating element to the sheet glass while the first primary articulated section is in the closed position and the first cross articulated section is in the open position, to cause gravity bending of the heated sheet glass in the cross direction and pivoting of the first cross articulated section to the closed position in response to a change in the weight distribution of the glass sheet on the cross swing.

16. The method of claim 15, wherein the first heating stage forms a predetermined, developable shape and the second heating stage forms the predetermined, non-developable shape.

17. The method of claim 15, further comprising: placing a heat shield between the heating element and the gravity bending tool before the second heating stage.

18. The method of claim 17, wherein the heat shield reduces heating to a predefined portion of the sheet glass.

19. The method of claim 18, wherein the predefined portion of the sheet glass is an outer annular portion of the sheet glass.

20. A method comprising:
placing a glass sheet on a gravity bending tool for bending glass sheets;
applying uniform heat in a first heating stage from a heating element to the sheet glass to cause gravity bending of the heated sheet glass in the primary direction to form a predetermined, developable shape;
applying non-uniform heat in a second heating stage from the heating element to the sheet glass to cause gravity bending of the heated sheet glass in the cross direction to form a predetermined, non-developable shape.
